(19) United States
(12) Patent Application Publication
(10) Pub. No.: US 2015/0135980 A1
(43) Pub. Date: May 21, 2015

(54) PHOTOGRAVURE PROCESS FOR IDENTIFICATION CODE

(71) Applicant: Chun-Huang LIN, Taipei City (TW)

(72) Inventor: Chun-Huang LIN, Taipei City (TW)

(21) Appl. No.: 14/608,941

(22) Filed: Jan. 29, 2015

Related U.S. Application Data
(63) Continuation-in-part of application No. 12/825,362, filed on Jun. 29, 2010.

(51) Int. Cl. G06K 1/12; B41F 31/02

(52) U.S. Cl. CPC G06K 1/121; B41F 31/02
USPC 101/483

(57) ABSTRACT

A photogravure process for an identification code includes providing a seamless steel tube as a press plate substrate; engraving an information of the identification code onto the press plate substrate; printing the information of the identification code on a plastic film made of PET to form an ink display layer; the plastic film made of PET being applied with a relative large pressing force to impress the ink in the shape of the information of the identification code, thereby forming an ink information layer; providing a layer of cellulose acetate arranged on the ink information layer for acting as a release layer; and providing a layer of hot-melt adhesive laminated beneath a ink display layer for acting as an adhesive layer. Therefore, the identification code printed has the benefits of solid and rich colors, clear graphics and letters, appropriate contrast, and realistic images.

### CROSS-REFERENCE TO RELATED APPLICATION

This application is a continuation-in-part of U.S. patent application Ser. No. 12/825,362 filed Jun. 29, 2010. The above application is incorporated by reference herein.

### BACKGROUND OF THE INVENTION

1. Technical Field

The present invention relates to printing technologies for identification codes, and more particularly to a photogravure process for an identification code.

2. Description of Related Art

At present, printing of identification codes is mainly relied on relief printing, which involves evenly distributing ink in the ink feed system of a printing press and then transferring the ink to the press plate through an ink roller, wherein since on the relief printing plate, the patterned part is much larger than un-patterned part, the ink on the ink roller can be only transferred to the patterned part of the press plate while the un-patterned part is left un-inked. The paper feed system of the printing press then delivers paper to the printing components of the printing press, so that with the cooperation of the press plate system and the impression system, the ink on the patterned part of the press plate is transferred to an object to be printed, thereby accomplishing the printing process and producing prints. Relief printing is subject to its printing velocity and excessive velocity can degrade clarity of the printed graphic or letters. Moreover, a relief printing plate typically produce thick prints which can bring about problems of set-off, mottles, moire patterns, glossless prints as well as poor color overlap. The patterned part is raised from the relief printing plate and tends to break under impact and the damaged plate has to be remade, suggesting a relatively high overall printing cost.

### SUMMARY OF THE INVENTION

The objective of the present invention is to overcome the shortcomings of the prior art by providing a photogravure process for an identification code, wherein the process is more efficient and less costly as compared with the prior art.

To achieve the above objective, the photogravure process of the present invention comprises:

providing a seamless steel tube as a press plate substrate, and engraving an information of the identification code onto the press plate substrate by means of laser engraving;

printing the information of the identification code by using a monochrome gravure printing press to print the information of the identification code on a plastic film made of PET;

adding ink to the press plate substrate so that the ink falls into recessed patterns of the information of the identification code naturally;

wiping up surplus ink on the surface of the press plate without removing the ink in the recessed pattern of the information of the identification code;

the plastic film made of PET being applied with a relative large pressing force in order to impress the ink in the shape of the information of the identification code onto the PET plastic film, thereby forming an ink information layer;

providing a layer of cellulose acetate arranged on the ink information layer for acting as a release layer; and

providing a layer of hot-melt adhesive laminated beneath the ink display layer for acting as an adhesive layer.

In one aspect of the present invention, the photogravure process further comprises a step of providing a bottom substrate which adheres to the adhesive layer.

Therefore the identification code printed through the photogravure process has the benefits of solid and rich colors, clear graphics and letters, appropriate contrast, and realistic images. In addition, the disclosed photogravure process allows high printing efficiency with a printing speed up to 100 m/min while the cost required is low.

### BRIEF DESCRIPTION OF THE DRAWING

FIG. 1 details the layer structure of the present Invention.

FIG. 2 shows the steps of the method of the present invention.

### DETAILED DESCRIPTION OF THE INVENTION

The embodiments given below are intended to facilitate the understanding of people skilled in the art to the present invention, without limiting the implement of the present invention in any respect.

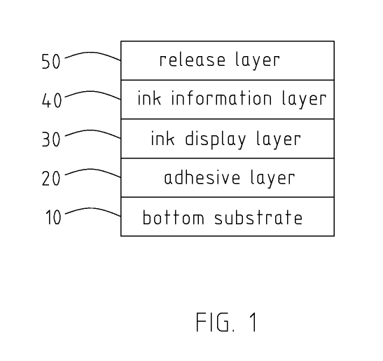

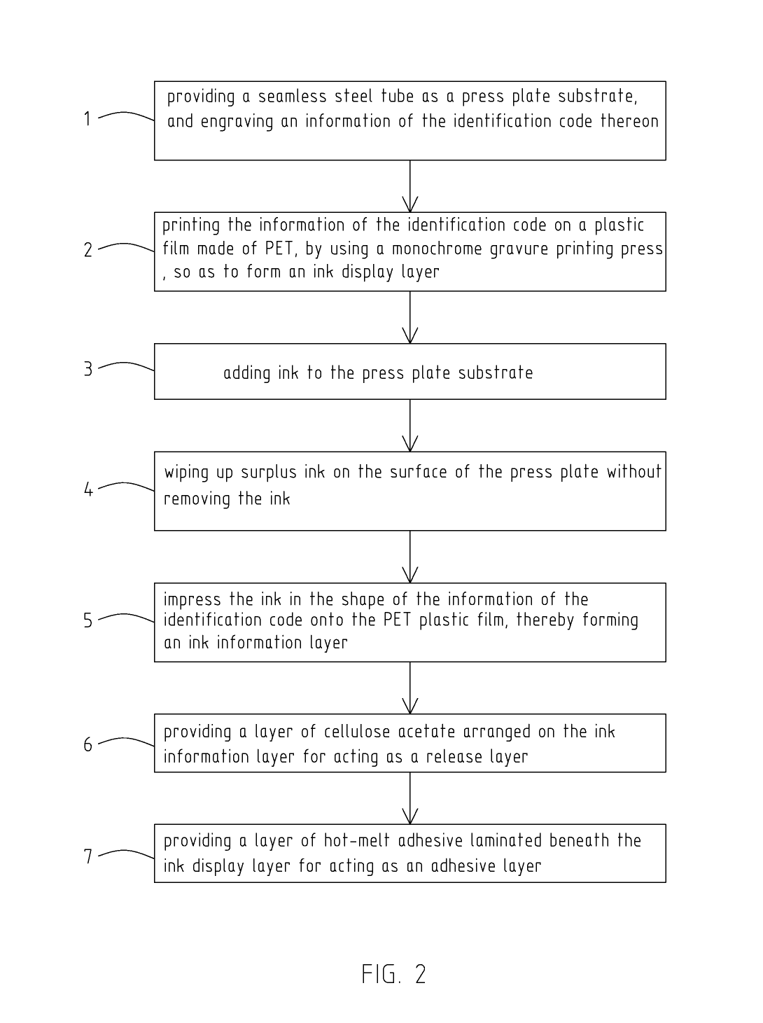

Referring to FIGS. 1 and 2 showing a preferable embodiment of the present invention, a photogravure process for an identification code comprises the following steps:

step 1: providing a seamless steel tube as a press plate substrate , and engraving an information of the identification code onto the press plate substrate by means of laser engraving;

step 2: printing the information of the identification code by using a monochrome gravure printing press to print the information of the identification code on a plastic film made of PET so as to form an ink display layer 30. As adopted herein, the ink is carbonic ink and the plastic film has a thickness of 5 μm;

step 3: In the course of printing, the ink is firstly added to the press plate substrate so that the ink falls into the recessed pattern of the information of the identification code naturally;

step 4: then the surplus ink on the surface of the press plate is wiped up without removing the ink in the recessed pattern of the information of the identification code;

step 5: afterward, the plastic film made of PET is placed thereon and a relative large pressing force is applied to impress the ink in the shape of the information of the identification code onto the PET plastic film, thereby forming an ink information layer 40;

step 6: a layer of cellulose acetate is arranged on the ink information layer 40 for acting as a release layer 5, whose thickness is 0.2 to 3 μm, preferably 0.2 μm;

step 7: a layer of hot-melt adhesive is laminated beneath the ink display layer 30 for acting as an adhesive layer 20 on a side of the plastic film made of PET opposite to the ink display layer 30, wherein the adhesive layer 20 has a thickness of 0.2 μm to 3 μm, preferably 0.2 μm; and

step 8: a bottom substrate 1 adheres to the adhesive layer 20, wherein the bottom substrate 10 is made of a foam or non-foam material, wherein the foam material is polyvinyl chloride (PVC), polyethylene (PE), or ethylene-propylene-octene (POE).

As a result, the identification code is thereby formed, and the layers as described above are arranged in an order that is, from bottom to top, the bottom substrate 10, the adhesive layer 20, the ink display layer 30, the ink information layer 40, and the release layer 50.

Accordingly, the identification code printed through the photogravure process of the present invention has the benefits of solid and rich colors, clear graphics and letters, appropriate contrast, and realistic images. In addition, the disclosed photogravure process allows high printing efficiency with a printing speed up to 100 m/min while the cost required is low.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A photogravure process for an identification code, the process comprising:
providing a seamless steel tube as a press plate substrate, and engraving an information of the identification code onto the press plate substrate by means of laser engraving;
printing the information of the identification code by using a monochrome gravure printing press to print the information of the identification code on a plastic film made of PET so as to form an ink display layer;
adding ink to the press plate substrate so that the ink falls into recessed patterns of the information of the identification code naturally;
wiping up surplus ink on the surface of the press plate without removing the ink in the recessed pattern of the information of the identification code;
the plastic film made of PET being applied with a relative large pressing force in order to impress the ink in the shape of the information of the identification code onto the PET plastic film, thereby forming an ink information layer;
providing a layer of cellulose acetate arranged on the ink information layer for acting as a release layer; and
providing a layer of hot-melt adhesive laminated beneath the ink display layer for acting as an adhesive layer.

2. The photogravure process of claim 1, further comprising a step of providing a bottom substrate which adheres to the adhesive layer.

3. The photogravure process of claim 2, wherein the bottom substrate is made of a foam or non-foam material.

4. The photogravure process of claim 3, wherein the foam material is polyvinyl chloride (PVC), polyethylene (PE), or ethylene-propylene-octene (POE).

5. The photogravure process of claim 1, wherein the film substrate is a piece of plastic film made of PET and the film has a thickness of 5˜20 μm.

6. The photogravure process of claim 1, wherein the release layer is a layer of cellulose acetate and has a thickness of 0.2˜3 μm.

7. The photogravure process of claim 1, wherein the adhesive layer is a layer of hot-melt adhesive and has a thickness of 0.2˜3 μm.
